(19) United States
(12) Patent Application Publication
(10) Pub. No.: US 2018/0335306 A1
(43) Pub. Date: Nov. 22, 2018

(54) METHOD AND APPARATUS FOR DETECTING ROAD LAYER POSITION

(71) Applicant: GM GLOBAL TECHNOLOGY OPERATIONS LLC, Detroit, MI (US)

(72) Inventors: Bing Deng, Bloomfield Hills, MI (US); Sarmad Y. Hermiz, Troy, MI (US); Xiaofeng F. Song, Novi, MI (US); Douglas A. Donaldson, Bloomfield Hills, MI (US); Steven R. Croyle, Bingham Farms, MI (US)

(21) Appl. No.: 15/596,698

(22) Filed: May 16, 2017

(51) Int. Cl. G01C 21/30; G01C 21/20

(52) U.S. Cl. CPC G01C 21/30; G01S 19/42; G01C 21/20

(57) ABSTRACT

A method and apparatus for detecting a road layer position are provided. The method includes reading sensor information including at least one from among global navigation system (GNS) information, image sensor information, ambient light information and inertial measurement sensor information, and determining a road layer position of a vehicle from among a plurality of road layers corresponding to a location of the vehicle based on the sensor information.

Apparatuses and methods consistent with exemplary embodiments relate to detecting a position of a vehicle on a road. More particularly, apparatuses and methods consistent with exemplary embodiments relate to detecting a position of a vehicle on multi-level or multi-layered area, road or path.

### SUMMARY

One or more exemplary embodiments provide a method and an apparatus that determine whether a road layer position of a vehicle on an area of road that includes multiple layers. More particularly, one or more exemplary embodiments provide a method and an apparatus that determine a road layer position of a vehicle based on information read from vehicle sensors and/or vehicle communication devices.

According to an exemplary embodiment, a method for detecting a road layer position is provided. The method includes reading sensor information, the sensor information comprising at least one from among global navigation system (GNS) information, image sensor information, ambient light information and inertial measurement sensor information, and determining a road layer position of a vehicle from among a plurality of road layers corresponding to a location of the vehicle based on the sensor information.

The method may further include detecting the location of the vehicle, determining whether the location of the vehicle includes the plurality of road layers, and the reading the sensor information may be performed in response to determining that the location of the vehicle includes the plurality of road layers.

The sensor information may include the GNS information including a signal strength, and the determining the road layer position of the vehicle may be performed based on the signal strength of the GNS information.

The determining the road layer position of the vehicle may include determining that the vehicle is on a top road layer from among the plurality of road layers if the signal strength of the GNS information is within a predetermined value from a preset GNS signal strength value corresponding to the top road layer and the location of the vehicle; and determining that the vehicle is on a layer beneath the top road layer from among the plurality of road layers if the signal strength of the GNS information is within a predetermined value from a preset GNS signal strength value corresponding to the layer beneath the top road layer and the location of the vehicle.

The sensor information may include the imaging information including an image of an environment corresponding to the location of the vehicle, and the determining the road layer position of the vehicle may be performed based on features detected in the image.

The determining the road layer position of the vehicle may include determining that the vehicle is on a top road layer from among the plurality of road layers if the features detected in the image information include at least one from among a sun, a moon, a star, a sky, and a cloud, and determining that the vehicle is on a layer beneath the top road layer from among the plurality of road layers if the features detected in the image information include at least one from among a pillar, a tunnel, a tunnel light, and a covered road.

The sensor information may include the ambient light information including a value of ambient light outside of the vehicle, and the determining the road layer position of the vehicle may be performed based on whether the value corresponding to ambient light outside of the vehicle is within a predetermined value from a preset ambient light value corresponding to a layer beneath the top road layer and the location of the vehicle.

The sensor information may include the inertial measurement sensor information including an acceleration value and a pitch rate, and the determining the road layer position of the vehicle may be performed based on the acceleration value and the pitch rate.

The determining the road layer position of the vehicle may include determining that the vehicle is on a top road layer from among the plurality of road layers if the acceleration value indicates a vertical acceleration and the pitch rate corresponds to a ramp profile of a ramp to the top road layer at the location of the vehicle, and determining that the vehicle is on a layer beneath the top road layer from among the plurality of road layers if the acceleration value indicates a vertical acceleration and the pitch rate corresponds to a ramp profile of a ramp to the layer beneath the top road layer at the location of the vehicle.

The determining the road layer position of the vehicle from among the plurality of road layers corresponding to the location of the vehicle based on the sensor information may include assigning a first score for status continuous confirmation based on weighted values of at least one from among the GNS information, the image sensor information, the ambient light information, assigning a second score for status transition detection based on weighted values of the inertial measurement sensor information, and determining the road layer position based on the assigned first score and the assigned second score.

According to an exemplary embodiment, an apparatus that detects a road layer position is provided. The apparatus includes at least one memory comprising computer executable instructions and at least one processor configured to read and execute the computer executable instructions. The computer executable instructions cause the at least one processor to read sensor information, the sensor information comprising at least one from among global navigation system (GNS) information, image sensor information, ambient light information and inertial measurement sensor information and determine a road layer position of a vehicle from among a plurality of road layers corresponding to a location of the vehicle based on the sensor information.

The computer executable instructions may cause the at least one processor to detect the location of the vehicle and determine whether the location of the vehicle includes the plurality of road layers. The computer executable instructions may cause the at least one processor to read the sensor information in response to determining that the location of the vehicle includes the plurality of road layers.

The sensor information may include the GNS information including a signal strength, and the computer executable instructions may cause the at least one processor to determine the road layer position of the vehicle based on the signal strength of the GNS information.

The computer executable instructions may cause the at least one processor to determine the road layer position of the vehicle by determining that the vehicle is on a top road layer from among the plurality of road layers if the signal strength of the GNS information is within a predetermined value from a preset GNS signal strength value corresponding to the top road layer and the location of the vehicle and determining that the vehicle is on a layer beneath the top road layer from among the plurality of road layers if the signal strength of the GNS information is within a predetermined value from a preset GNS signal strength value corresponding to the layer beneath the top road layer and the location of the vehicle.

The sensor information may include the imaging information including an image of an environment corresponding to the location of the vehicle, and the computer executable instructions may further cause the at least one processor to determine the road layer position of the vehicle based on features detected in the image.

The computer executable instructions may further cause the at least one processor to determine the road layer position of the vehicle by determining that the vehicle is on a top road layer from among the plurality of road layers if the features detected in the image information include at least one from among a sun, a moon, a star, a sky, and a cloud, and determining that the vehicle is on a layer beneath the top road layer from among the plurality of road layers if the features detected in the image information include at least one from among a pillar, a tunnel, a tunnel light, and a covered road.

The sensor information may include the ambient light information including a value of ambient light outside of the vehicle, and the computer executable instructions may further cause the at least one processor to determine the road layer position of the vehicle based on whether the value corresponding to ambient light outside of the vehicle is within a predetermined value from a preset ambient light value corresponding to a layer beneath the top road layer and the location of the vehicle.

The sensor information may include the inertial measurement sensor information including an acceleration value and a pitch rate and the computer executable instructions may further cause the at least one processor to determine the road layer position of the vehicle based on the acceleration value and the pitch rate.

The computer executable instructions may further cause the at least one processor to determine the road layer position of the vehicle by determining that the vehicle is on a top road layer from among the plurality of road layers if the acceleration value indicates a vertical acceleration and the pitch rate corresponds to a ramp profile of a ramp to the top road layer at the location of the vehicle; and determining that the vehicle is on a layer beneath the top road layer from among the plurality of road layers if the acceleration value indicates a vertical acceleration and the pitch rate corresponds to a ramp profile of a ramp to the layer beneath the top road layer at the location of the vehicle.

According to an exemplary embodiment, a non-transitory computer readable medium comprising computer instructions executable to perform a method is provided. The method includes detecting the location of the vehicle, determining whether the location of the vehicle includes a plurality of road layers, in response to determining that the location of the vehicle is a location with a plurality of road layers, reading sensor information comprising at least one from among global navigation system (GNS) information, image sensor information, ambient light information and inertial measurement sensor information, and determining a road layer position of a vehicle from among a plurality of road layers corresponding to a location of the vehicle based on the sensor information.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an apparatus that detects a road layer position according to an exemplary embodiment;

FIG. 2 shows a flowchart for a method of detecting road layer position according to an exemplary embodiment;

FIG. 3A shows a flowchart for a method of detecting road layer position according to an exemplary embodiment;

FIG. 3B shows a flowchart for a method of determining road layer position according to an aspect of an exemplary embodiment; and

FIG. 4 shows illustrations of transitioning between layers of a multi-layer road according to an aspect of an exemplary embodiment.

### DETAILED DESCRIPTION OF EXEMPLARY EMBODIMENTS

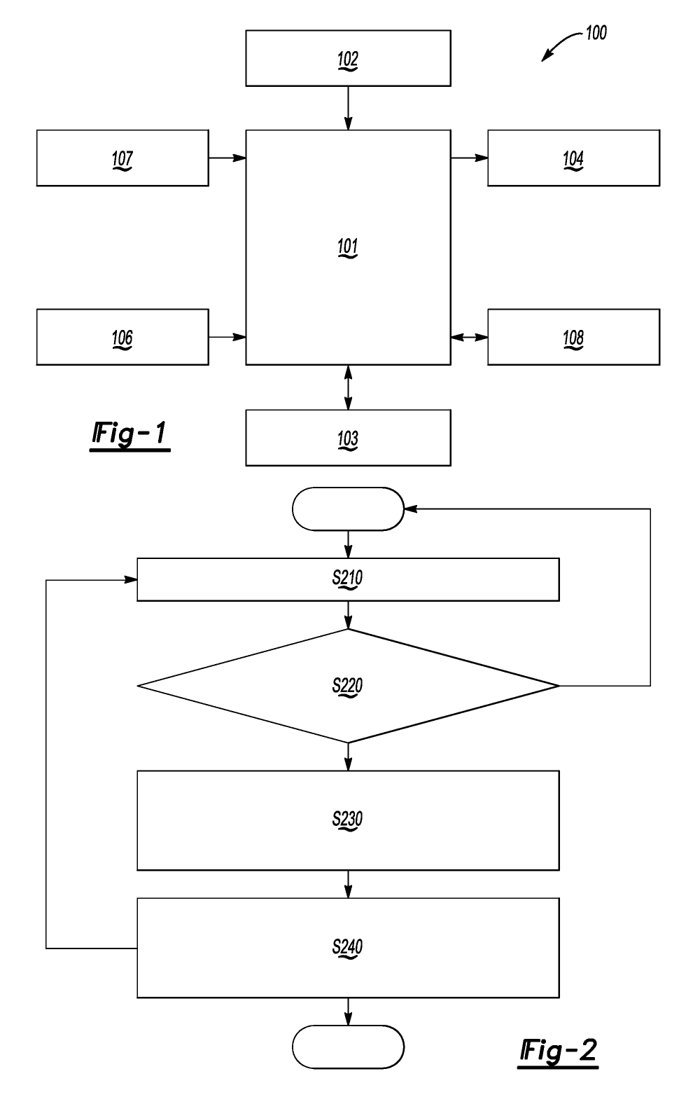

An apparatus and method for detecting road layer position will now be described in detail with reference to FIGS. 1-4 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “attached to,” “formed on,” or “disposed on” a second element, the first element may be connected directly to, formed directly on or disposed directly on the second element or there may be intervening elements between the first element and the second element, unless it is stated that a first element is “directly” connected to, attached to, formed on, or disposed on the second element. In addition, if a first element is configured to “send” or “receive” information from a second element, the first element may send or receive the information directly to or from the second element, send or receive the information via a bus, send or receive the information via a network, or send or receive the information via intermediate elements, unless the first element is indicated to send or receive information “directly” to or from the second element.

Throughout the disclosure, one or more of the elements disclosed may be combined into a single device or into one or more devices. In addition, individual elements may be provided on separate devices.

Vehicles are being equipped with sensors that are capable of detecting conditions of an environment around a vehicle. The sensors provide information on conditions or features of location of a vehicle and this information may be used to control the vehicle or to assist an operator of a vehicle. One such environment is a multi-layer or a multi-level environment such as an elevated highway, a tunnel, a multi-level bridge, etc.

Often, location information alone is not sufficient for determining the road layer position, i.e., the road, path or level of a multi-layered or multi-level area in which a vehicle is located. As such, sensor information or information from sensors or communication devices of a vehicle may be used in addition to the location information to make a more accurate determination as to the position and location of the vehicle.

This more accurate determination of road layer position may be used to provide better navigation information, autonomous vehicle control, and map creation. In one example, multi-layered or multi-level roads may be more accurately mapped by sensors. In another example, an autonomous vehicle may better be able to navigate by accurately determining a correct road layer position, and the features, speed limit, and path of the correct road layer position. In yet another example, mapping information can be gathered more accurately because a mapping engine may be better able to determine a road layer position associated with mapped features.

FIG. 1 shows a block diagram of an apparatus that detects road layer position 100 according to an exemplary embodiment. As shown in FIG. 1, the apparatus that detects road layer position 100, according to an exemplary embodiment, includes a controller 101, a power supply 102, a storage 103, an output 104, a user input 106, a sensor 107, and a communication device 108. However, the apparatus that detects road layer position 100 is not limited to the aforementioned configuration and may be configured to include additional elements and/or omit one or more of the aforementioned elements. The apparatus that detects road layer position 100 may be implemented as part of a vehicle, as a standalone component, as a hybrid between an on vehicle and off vehicle device, or in another computing device.

The controller 101 controls the overall operation and function of the apparatus that detects road layer position 100. The controller 101 may control one or more of a storage 103, an output 104, a user input 106, a sensor 107, and a communication device 108 of the apparatus that detects road layer position 100. The controller 101 may include one or more from among a processor, a microprocessor, a central processing unit (CPU), a graphics processor, Application Specific Integrated Circuits (ASICs), Field-Programmable Gate Arrays (FPGAs), state machines, circuitry, and a combination of hardware, software and firmware components.

The controller 101 is configured to send and/or receive information from one or more of the storage 103, the output 104, the user input 106, the sensor 107, and the communication device 108 of the apparatus that detects road layer position 100. The information may be sent and received via a bus or network, or may be directly read or written to/from one or more of the storage 103, the output 104, the user input 106, the sensor 107, and the communication device 108 of the apparatus that detects road layer position 100. Examples of suitable network connections include a controller area network (CAN), a media oriented system transfer (MOST), a local interconnection network (LIN), a local area network (LAN), wireless networks such as Bluetooth and 802.11, and other appropriate connections such as Ethernet and FlexRay.

The power supply 102 provides power to one or more of the controller 101, the storage 103, the output 104, the user input 106, the sensor 107, and the communication device 108, of the apparatus that detects road layer position 100. The power supply 102 may include one or more from among a battery, an outlet, a capacitor, a solar energy cell, a generator, a wind energy device, an alternator, etc.

The storage 103 is configured for storing information and retrieving information used by the apparatus that detects road layer position 100. The storage 103 may be controlled by the controller 101 to store and retrieve information received from the controller 101, the sensor 107, and/or the communication device 108. The information may include Global Navigation System (GNS) information, image sensor information, ambient light information and inertial measurement sensor information, etc. The storage 103 may also store the computer instructions configured to be executed by a processor to perform the functions of the apparatus that detects road layer position 100.

The GNS information may include a signal strength of a GPS signal or other GNS signal. GNS systems may include GPS, GLONASS, BeiDou, Compass, IRNSS and any other wireless communication or satellite based navigation system. In addition, the imaging information may include an image of an environment corresponding to the location of the vehicle. Further, the ambient light information may include a value of ambient light outside of the vehicle. Further still, the inertial measurement sensor information may include one or more from among an acceleration value and a pitch rate.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the apparatus that detects road layer position 100. The output 104 may include one or more from among a speaker, an audio device, a display, a centrally-located display, a head up display, a windshield display, a haptic feedback device, a vibration device, a tactile feedback device, a tap-feedback device, a holographic display, an instrument light, an indicator light, etc. According to one example, the output 104 may output information on the location of the vehicle on a roadway to be used by an autonomous driving system or a navigation system.

The output 104 may output notification including one or more from among an audible notification, a light notification, and a display notification. The notifications may indicate information on a road layer position of a vehicle or a location of a vehicle. Moreover, the output 104 may output navigation information based on the road layer position of a vehicle and/or a location of a vehicle.

The user input 106 is configured to provide information and commands to the apparatus that detects road layer position 100. The user input 106 may be used to provide user inputs, etc., to the controller 101. The user input 106 may include one or more from among a touchscreen, a keyboard, a soft keypad, a button, a motion detector, a voice input detector, a microphone, a camera, a trackpad, a mouse, a steering wheel, a touchpad, etc. The user input 106 may be configured to receive a user input to acknowledge or dismiss the notification output by the output 104.

The sensor 107 may include one or more from among a plurality of sensors including a camera, a laser sensor, an ultrasonic sensor, an infrared camera, a LIDAR, a radar sensor, an ultra-short range radar sensor, an ultra-wideband radar sensor, and a microwave sensor. The sensor 107 may be configured to scan an area around a vehicle to detect and provide image information including an image of the area around the vehicle or ambient light information including an ambient light level of the area around the vehicle. In addition, the sensor 107 may provide an acceleration value and a pitch rate of a vehicle.

The communication device 108 may be used by the apparatus that detects road layer position 100 to communicate with various types of external apparatuses according to various communication methods. The communication device 108 may be used to send/receive information including the information on a location of a vehicle, the information on a road layer position of a vehicle, the GNS or GPS information, the image sensor information, the ambient light information and the inertial measurement sensor information, etc.

The communication device 108 may include various communication modules such as one or more from among a telematics unit, a broadcast receiving module, a near field communication (NFC) module, a GPS receiver, a GNS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS or GNS receiver is a module that receives a GPS or GNS signal from a GPS or GNS satellite or tower and detects a current location. The wired communication module may be a module that receives information over a wired network such as a local area network, a controller area network (CAN), or an external network. The wireless communication module is a module that is connected to an external network by using a wireless communication protocol such as IEEE 802.11 protocols, WiMAX, Wi-Fi or IEEE communication protocol and communicates with the external network. The wireless communication module may further include a mobile communication module that accesses a mobile communication network and performs communication according to various mobile communication standards such as 3^{rd} generation (3G), 3^{rd} generation partnership project (3GPP), long-term evolution (LTE), Bluetooth, EVDO, CDMA, GPRS, EDGE or ZigBee.

According to another exemplary embodiment, the controller 101 of the apparatus that detects road layer position 100 may be configured to read sensor information, the sensor information comprising at least one from among GNS information, image sensor information, ambient light information and inertial measurement sensor information, and determine a road layer position of a vehicle from among a plurality of road layers corresponding to a location of the vehicle based on the sensor information.

The controller 101 of the apparatus that detects road layer position 100 may be further configured to detect the location of the vehicle and determine whether the location of the vehicle includes the plurality of road layers. The controller 101 may read the sensor information in response to determining that the location of the vehicle includes the plurality of road layers.

The controller 101 of the apparatus that detects road layer position 100 may be configured to determine the road layer position of the vehicle based on the signal strength of the GNS information. In addition, the controller 101 of the apparatus that detects road layer position 100 may be configured to determine that the vehicle is on a top road layer from among the plurality of road layers if the signal strength of the GNS information is within a predetermined value from a preset GNS signal strength value corresponding to the top road layer and the location of the vehicle and determine that the vehicle is on a layer beneath the top road layer from among the plurality of road layers if the signal strength of the GNS information is within a predetermined value from a preset GNS signal strength value corresponding to the layer beneath the top road layer and the location of the vehicle.

The controller 101 of the apparatus that detects road layer position 100 may be configured to determine the road layer position of the vehicle based on features detected in an image of an environment corresponding to the location of the vehicle. In addition, the controller 101 of the apparatus that detects road layer position 100 may be configured to determine that the vehicle is on a top road layer from among the plurality of road layers if the features detected in the image information include at least one from among a sun, a moon, a star, a sky, and a cloud and determine that the vehicle is on a layer beneath the top road layer from among the plurality of road layers if the features detected in the image information include at least one from among a pillar, a tunnel, a tunnel light, and a covered road.

The controller 101 of the apparatus that detects road layer position 100 may be configured to determine the road layer position of the vehicle based on whether the value corresponding to ambient light outside of the vehicle is within a predetermined value from a preset ambient light value corresponding to a layer beneath the top road layer and the location of the vehicle.

The controller 101 of the apparatus that detects road layer position 100 may be configured to determine the road layer position of the vehicle based on the acceleration value and the pitch rate. In addition, the controller 101 of the apparatus that detects road layer position 100 may be configured to determine that the vehicle is on a top road layer from among the plurality of road layers if the acceleration value indicates a vertical acceleration and the pitch rate corresponds to a ramp profile of a ramp to the top road layer at the location of the vehicle, and determine that the vehicle is on a layer beneath the top road layer from among the plurality of road layers if the acceleration value indicates a vertical acceleration and the pitch rate corresponds to a ramp profile of a ramp to the layer beneath the top road layer at the location of the vehicle.

FIG. 2 shows a flowchart for a method of detecting road layer position according to an exemplary embodiment. The method of FIG. 2 may be performed by the apparatus that detects road layer position 100 or may be encoded into a computer readable medium as instructions that are executable by a computer to perform the method.

Referring to FIG. 2, the location of the vehicle is detected in operation S210. In operation S220, it is determined whether the detected location includes a plurality of road layers. If the detected location includes a plurality of road layers (operation S220—Yes), the method proceeds to operation S230 to read and process sensor information. If the detected location does not include a plurality of road layers or is single layer road or path (operation S220—No), the process resets.

In operation S230, sensor information from one or more sensors or communication devices is read and/or processed. The sensor information may include GPS or GNS information, image sensor information, ambient light information or inertial measurement sensor information. Then, in operation S240, a determination or selection of a road layer position of a vehicle from among the plurality of road layers corresponding to the location of the vehicle is made based on the sensor information. The road layer position may then be output, written to memory or transmitted to be used to control the vehicle, determine navigation or route information, or display location and/or position information of the vehicle.

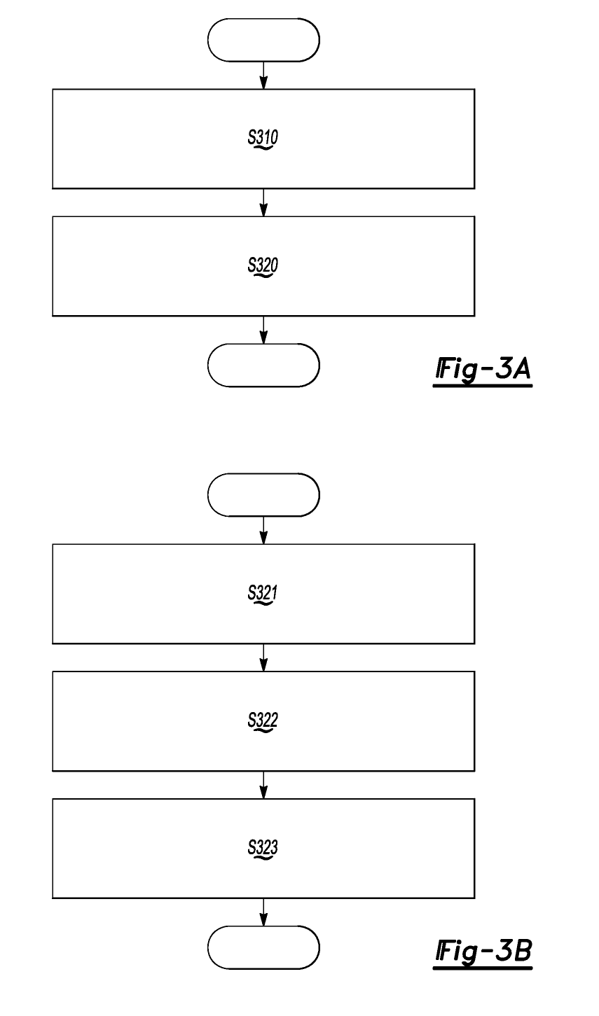

FIG. 3A shows a flowchart for a method of detecting road layer position according to an exemplary embodiment. The method of FIG. 3A may be performed by the apparatus that detects road layer position 100 or may be encoded into a computer readable medium as instructions that are executable by a computer to perform the method.

Referring to FIG. 3A, sensor information from one or more sensors or communication devices is read and/or processed in operation S310. The sensor information may include GPS or GNS information, image sensor information, ambient light information or inertial measurement sensor information. Then, in operation S310, a determination or selection of a road layer position of a vehicle from among the plurality of road layers corresponding to the location of the vehicle is made based on the sensor information. The road layer position may be then be output, written to memory or transmitted to be used to control the vehicle, determine navigation or route information, or display location and/or position information of the vehicle.

FIG. 3B shows a flowchart for a method of determining road layer position according to an aspect of an exemplary embodiment. The method of FIG. 3B may be performed by the apparatus that detects road layer position 100 or may be encoded into a computer readable medium as instructions that are executable by a computer to perform the method.

Referring to FIG. 3B, a first score for status continuous confirmation is assigned based on weighted values of at least one from among the GPS or GNS information, the image sensor information, the ambient light information in operation S321. In operation S322, a second score for status transition detection based on weighted values of the inertial measurement sensor information. For example, a score of zero may be assigned when a vehicle is not on a ramp as determine from the inertial measurement sensor information. Based on the assigned first score and the assigned second score, the road layer position of a vehicle is determined in operation S323.

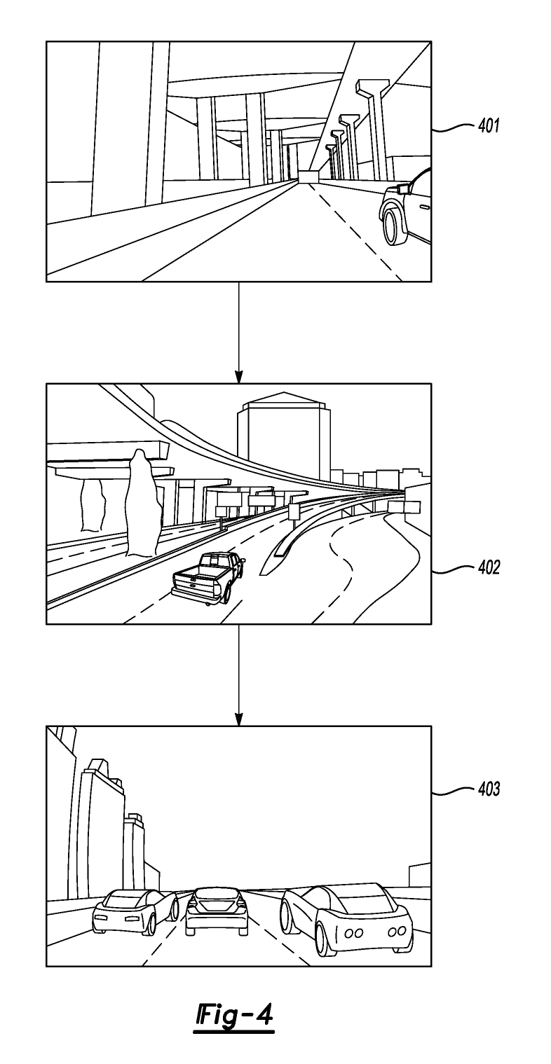

FIG. 4 shows illustrations of transitioning between layers of a multi-layer road according to an aspect of an exemplary embodiment. Referring to FIG. 4, a first image 401 shows an environment when traveling on a lower layer of a multi-layer road or highway. The features of the environment of the first image 401 include columns and pillars, less ambient light due to the presence of canopy, and a weaker GPS or GNS signal due to the presence of the canopy. These features may be detected through the use of a sensor and a communication device and information on these features may be used to determine that the road layer position of the vehicle is beneath the top layer.

A third image 403 shows an environment when traveling on a top layer of a multi-layer road or highway. The features of the environment of the third image 403 may include a sky, clouds, ambient light greater than a predetermined threshold, a lack of columns, a stronger communication signal due to the lack of canopy, stars, sun, moon, etc. The information on the features of the top layer of a multi-layer road or highway may be used to determine that the road layer position of the vehicle is beneath the top layer.

Moreover, second image 402 shows a ramp that allows for a transition between lower layer of a multi-layer road and a top layer of a multi-layer road. The ramp may be detected via imaging and features of the transition while traveling on the ramp may include speed, pitch, acceleration, vertical acceleration, etc. The information on the features of the ramp that allows for a transition between lower layer of a multi-layer road and a top layer of a multi-layer road of a multi-layer road or highway may be used to determine that the road layer position of the vehicle is beneath the top layer.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A method for detecting a road layer position, the method comprising:
reading sensor information, the sensor information comprising at least one from among global navigation system (GNS) information, image sensor information, ambient light information and inertial measurement sensor information; and
determining a road layer position of a vehicle from among a plurality of road layers corresponding to a location of the vehicle based on the sensor information.

2. The method of claim 1, further comprising:
detecting the location of the vehicle;
determining whether the location of the vehicle includes the plurality of road layers,
wherein the reading the sensor information is performed in response to determining that the location of the vehicle includes the plurality of road layers.

3. The method of claim 1, wherein the sensor information comprises the GNS information including a signal strength, and
wherein the determining the road layer position of the vehicle is performed based on the signal strength of the GNS information.

4. The method of claim 3, wherein the determining the road layer position of the vehicle comprises:
determining that the vehicle is on a top road layer from among the plurality of road layers if the signal strength of the GNS information is within a predetermined value from a preset GNS signal strength value corresponding to the top road layer and the location of the vehicle; and
determining that the vehicle is on a layer beneath the top road layer from among the plurality of road layers if the signal strength of the GNS information is within a predetermined value from a preset GNS signal strength value corresponding to the layer beneath the top road layer and the location of the vehicle.

5. The method of claim 1, wherein the sensor information comprises the imaging information including an image of an environment corresponding to the location of the vehicle, and
wherein the determining the road layer position of the vehicle is performed based on features detected in the image.

6. The method of claim 5, wherein the determining the road layer position of the vehicle comprises:
determining that the vehicle is on a top road layer from among the plurality of road layers if the features detected in the image information include at least one from among a sun, a moon, a star, a sky, and a cloud; and
determining that the vehicle is on a layer beneath the top road layer from among the plurality of road layers if the features detected in the image information include at least one from among a pillar, a tunnel, a tunnel light, and a covered road.

7. The method of claim 1, wherein the sensor information comprises the ambient light information including a value of ambient light outside of the vehicle, and
wherein the determining the road layer position of the vehicle is performed based on whether the value corresponding to ambient light outside of the vehicle is within a predetermined value from a preset ambient light value corresponding to a layer beneath the top road layer and the location of the vehicle.

8. The method of claim 1, wherein the sensor information comprises the inertial measurement sensor information including an acceleration value and a pitch rate, and
wherein the determining the road layer position of the vehicle is performed based on the acceleration value and the pitch rate.

9. The method of claim 8, wherein the determining the road layer position of the vehicle comprises:
determining that the vehicle is on a top road layer from among the plurality of road layers if the acceleration value indicates a vertical acceleration and the pitch rate corresponds to a ramp profile of a ramp to the top road layer at the location of the vehicle; and
determining that the vehicle is on a layer beneath the top road layer from among the plurality of road layers if the acceleration value indicates a vertical acceleration and the pitch rate corresponds to a ramp profile of a ramp to the layer beneath the top road layer at the location of the vehicle.

10. The method of claim 1, wherein the determining the road layer position of the vehicle from among the plurality of road layers corresponding to the location of the vehicle based on the sensor information comprises:
assigning a first score for status continuous confirmation based on weighted values of at least one from among the GNS information, the image sensor information, the ambient light information;
assigning a second score for status transition detection based on weighted values of the inertial measurement sensor information;
determining the road layer position based on the assigned first score and the assigned second score.

11. An apparatus that detects a road layer position, the apparatus comprising:
at least one memory comprising computer executable instructions; and
at least one processor configured to read and execute the computer executable instructions, the computer executable instructions causing the at least one processor to:
read sensor information, the sensor information comprising at least one from among global navigation system (GNS) information, image sensor information, ambient light information and inertial measurement sensor information; and
determine a road layer position of a vehicle from among a plurality of road layers corresponding to a location of the vehicle based on the sensor information.

12. The apparatus of claim 11, wherein the computer executable instructions cause the at least one processor to:
detect the location of the vehicle;
determine whether the location of the vehicle includes the plurality of road layers,
wherein the computer executable instructions cause the at least one processor to read the sensor information in response to determining that the location of the vehicle includes the plurality of road layers.

13. The apparatus of claim 11, wherein the sensor information comprises the GNS information including a signal strength, and
wherein the computer executable instructions cause the at least one processor to determine the road layer position of the vehicle based on the signal strength of the GNS information.

14. The apparatus of claim 13, wherein the computer executable instructions cause the at least one processor to determine the road layer position of the vehicle by:
determining that the vehicle is on a top road layer from among the plurality of road layers if the signal strength of the GNS information is within a predetermined value from a preset GNS signal strength value corresponding to the top road layer and the location of the vehicle; and
determining that the vehicle is on a layer beneath the top road layer from among the plurality of road layers if the signal strength of the GNS information is within a predetermined value from a preset GNS signal strength value corresponding to the layer beneath the top road layer and the location of the vehicle.

15. The apparatus of claim 11, wherein the sensor information comprises the imaging information including an image of an environment corresponding to the location of the vehicle, and
wherein the computer executable instructions further cause the at least one processor to determine the road layer position of the vehicle based on features detected in the image.

16. The apparatus of claim 15, wherein the computer executable instructions further cause the at least one processor to determine the road layer position of the vehicle by:
determining that the vehicle is on a top road layer from among the plurality of road layers if the features detected in the image information include at least one from among a sun, a moon, a star, a sky, and a cloud; and
determining that the vehicle is on a layer beneath the top road layer from among the plurality of road layers if the features detected in the image information include at least one from among a pillar, a tunnel, a tunnel light, and a covered road.

17. The apparatus of claim 11, wherein the sensor information comprises the ambient light information including a value of ambient light outside of the vehicle, and
wherein the computer executable instructions further cause the at least one processor to determine the road layer position of the vehicle based on whether the value corresponding to ambient light outside of the vehicle is within a predetermined value from a preset ambient light value corresponding to a layer beneath the top road layer and the location of the vehicle.

18. The apparatus of claim 11, wherein the sensor information comprises the inertial measurement sensor information including an acceleration value and a pitch rate,
wherein the computer executable instructions further cause the at least one processor to determine the road layer position of the vehicle based on the acceleration value and the pitch rate.

19. The apparatus of claim 11, wherein the computer executable instructions further cause the at least one processor to determine the road layer position of the vehicle by:
determining that the vehicle is on a top road layer from among the plurality of road layers if the acceleration value indicates a vertical acceleration and the pitch rate corresponds to a ramp profile of a ramp to the top road layer at the location of the vehicle; and
determining that the vehicle is on a layer beneath the top road layer from among the plurality of road layers if the acceleration value indicates a vertical acceleration and the pitch rate corresponds to a ramp profile of a ramp to the layer beneath the top road layer at the location of the vehicle.

20. A non-transitory computer readable medium comprising computer instructions executable to perform a method, the method comprising:
detecting the location of the vehicle;
determining whether the location of the vehicle includes a plurality of road layers,
in response to determining that the location of the vehicle is a location with a plurality of road layers, reading sensor information comprising at least one from among global navigation system (GNS) information, image sensor information, ambient light information and inertial measurement sensor information; and
determining a road layer position of a vehicle from among a plurality of road layers corresponding to a location of the vehicle based on the sensor information.
